(19) United States
(12) Patent Application Publication
(10) Pub. No.: US 2015/0096608 A1
(43) Pub. Date: Apr. 9, 2015

(54) FIXING APPARATUS FOR BALL LENS

(71) Applicant: ATOMIC ENERGY COUNCIL - INSTITUTE OF NUCLEAR ENERGY RESEARCH, TAOYUAN COUNTY (TW)

(72) Inventors: YUEH-MU LEE, TAOYUAN COUNTY (TW); ZUN-HAO SHIH, TAOYUAN COUNTY (TW); YI-PING LIANG, TAOYUAN COUNTY (TW); HWA-YUH SHIN, TAOYUAN COUNTY (TW); HWEN-FEN HONG, TAOYUAN COUNTY (TW)

(73) Assignee: ATOMIC ENERGY COUNCIL - INSTITUTE OF NUCLEAR ENERGY RESEARCH, TAOYUAN COUNTY (TW)

(21) Appl. No.: 14/048,239

(22) Filed: Oct. 8, 2013

(51) Int. Cl. G02B 7/02; H02S 40/22; F16M 11/22

(52) U.S. Cl. CPC G02B 7/027; F16M 11/22; H02S 40/22
USPC 136/252; 211/14

(57) ABSTRACT

The present invention relates to a fixing apparatus for ball lens used for facilitating installation of concentrator solar cell receiver module. The present invention can finish installing the fixing base for ball lens at a time and positioning the ball lens rapidly and accurately. It can also control the distance between the ball lens and the solar cell excellently. In addition, the present invention further has the function of sheltering the circuit of concentrator solar cell receiver module. When off-axis illumination of sunlight occurs, direct illumination of sunlight on, and consequently high-temperature burnout of, the circuit can be avoided. Thereby, the lifetime of the circuit can be extended effectively and the probability of failure can be reduced as well.

### FIELD OF THE INVENTION

The present invention relates generally to a fixing apparatus for ball lens, and particularly to a fixing apparatus for ball lens used for improving the assembly efficiency and accuracy of a concentrator solar cell receiver module as well as protecting its circuit from burnout due to the off-axis illumination of sunlight.

### BACKGROUND OF THE INVENTION

The most basic operational method of solar power generation is to illuminate sunlight on the surface of solar cells. Currently, there is a concentrator solar cell receiver module, which uses a concentrating lens to concentrate more photo energy for enhancing power generating efficiency. These concentrator solar cell receiver modules shrink the size of solar cells by increasing the concentrating multiple and using automatic production. Consequently, the costs of the materials for solar cells can be saved.

In practice, small-area solar cells need to use secondary optical devices such as ball lenses for shrinking concentrating spots, increasing tolerance of sunlight angle, and shortening focal length. Nonetheless, the current fixing method for ball lens is relatively difficult and complicated.

Please refer to FIG. 1, which shows a side cross-sectional view of the structure according to the prior art. As shown in the figure, a conductive circuit 62 is disposed on a substrate 61 of a concentrator solar cell receiver module. The conductive circuit 62 includes multiple conductive blocks. A solar cell 63 is disposed on one of the conductive blocks. The solar cell 63 is connected electrically with other conductive blocks using gold wires. A ball lens 5 is located right above the solar cell 63, and is fixed and supported by two pads 8 on both sides.

According to the structure according to the prior art as shown in FIG. 1, the whole process of installing the ball lens 5 is quite complicated and the accuracy is difficult to be controlled. A user must first install the pads 8 one by one to the substrate 61 or the conductive circuit 62. Then the ball lens 5 is placed. The concentrator solar cell receiver module is not applied alone. Instead, it is arranged is a large-area array. Thereby, if the pads 8 should be installed to each of the concentrator solar cell receiver modules one by one, the overall installation process, no matter manually or automatically, will consume substantial time and resources. In addition, it is unavoidable that the locations of the pads 8 are deviated and thus influencing the focusing effect of the ball lenses. Accordingly, the operational efficiency is reduced.

FIG. 2 shows another apparatus for fixing ball lens according to the prior art. In the apparatus, the pads 8 described above are not adopted. Instead, an O-ring 9 is used. The ball lens 5 is placed on and supported by the O-ring 9, which is installed at the same location of the pads 8. The problem of this technology is, just like using the pads 8, that the concerns of complicated installation and deviation in locations still exist.

Another important issue of the prior art is that when the sunlight is off-axis, the focused light by the concentrating lens 65 may not be concentrated at the ball lens 5; it may illuminate directly on other devices, such as the conductive circuit 62, of the concentrator solar cell receiver module. Because the focus temperature may reach as high as 1100° C., if the material of the conductive circuit 62 is copper, which has a melting point of 1083° C., it will be burned out.

Accordingly, given the requirement of using ball lenses for miniature concentrator solar cell receiver modules and considering their complicated installation, difficult control of their accuracy, and the risk of permanent damage in structure due to off-axis illumination of sunlight for applications without or with malfunctioned sun tracking systems, it is necessary to provide a solution for these issues for reducing the manufacturing and operating costs of the solar power generating systems and thus increasing their market values.

### SUMMARY

An objective of the present invention is to provide a fixing apparatus for ball lens, which is exempt from installation of supporting devices such as pads or O-rings one by one when a user is installing the ball lenses of a concentrator solar cell receiver module. Hence, the processing steps are reduced substantially. The installation of fixing apparatuses for ball lens to a power generating array with a great amount of solar cells can be finished at a time. Thereby, the operating efficiency is enhanced. In addition, the structural flaws in products caused by positioning errors of pads or O-rings can be avoided.

Another objective of the present invention is to provide a fixing apparatus for ball lens. In addition to improving the processing efficiency, the circuit board of the concentrator solar cell receiver module is also sheltered and protected. Thereby, damages and burnout of the circuit board due to off-axis illumination can be prevented.

For achieving the objectives described above, the present invention discloses a fixing apparatus for ball lens used for fixing at least a ball lens of a concentrator solar cell receiver module. The structure of the fixing apparatus comprises a plate and at least a fixing recess. The plate has a plurality of supporting legs underneath. The fixing recess is disposed on the surface of the plate and has a gap part at its bottom and penetrating the plate. The diameter or the longest diagonal of the gap part is shorter than the diameter of the ball lens. Besides, the ball lens contacts the top of an inner edge of the gap part. According to the design of the structure, after the solar cell receiver is placed on the substrate, the circuit intolerable of high temperature can be protected from burnout due to off-axis illumination of sunlight. In addition, the installation speed and quality of ball lens are improved significantly.

### BRIEF DESCRIPTION OF THE DRAWINGS

FIG. 1 shows a side cross-sectional view of the structure according to the prior art;

FIG. 2 shows a schematic diagram of installing the ball lens to an O-ring according to the prior art;

FIG. 3 shows a structural schematic diagram according to a preferred embodiment of the present invention;

FIG. 4 shows a structural schematic diagram of rectangular fixing recesses and gap parts according a preferred embodiment of the present invention;

FIG. 5 shows a structural schematic diagram of circular gap parts according a preferred embodiment of the present invention;

FIG. 6 shows a side cross-sectional view of installing the present invention on a solar cell receiver module;

FIG. 7 shows a partially enlarged view of FIG. 6;

FIG. 8A shows a schematic diagram of the diameter of the circuit gap part according to the present invention;

FIG. 8B shows a schematic diagram of the longest diagonal of the polygonal gap part according to the present invention; and

FIG. 9 shows a structural schematic diagram according another preferred embodiment of the present invention.

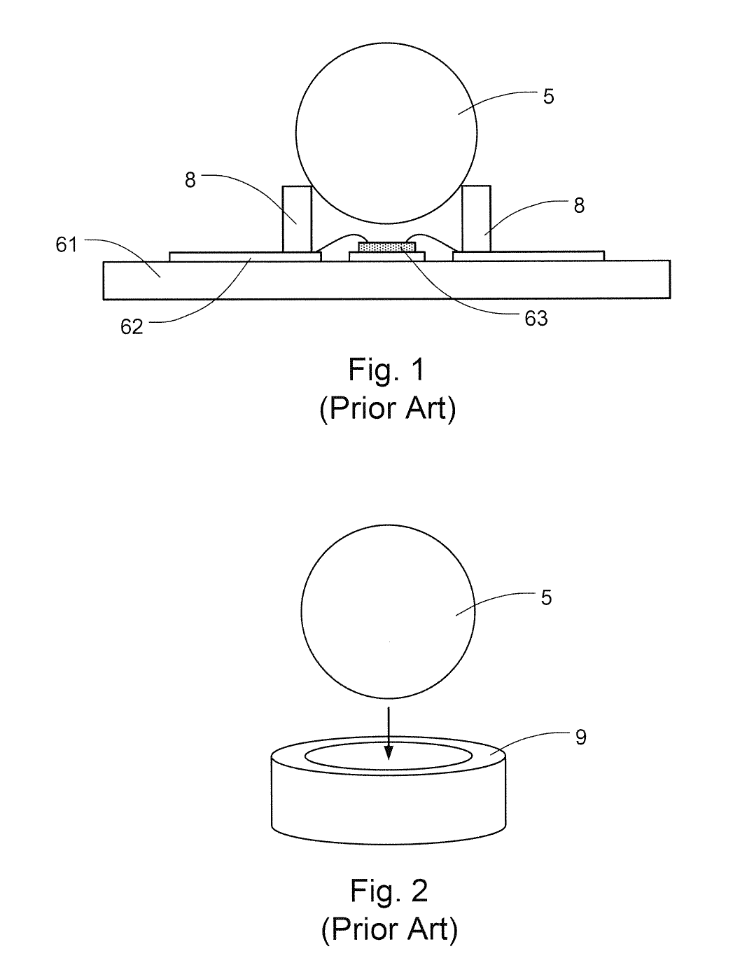

### DETAILED DESCRIPTION

In order to make the structure and characteristics as well as the effectiveness of the present invention to be further understood and recognized, the detailed description of the present invention is provided as follows along with embodiments and accompanying figures.

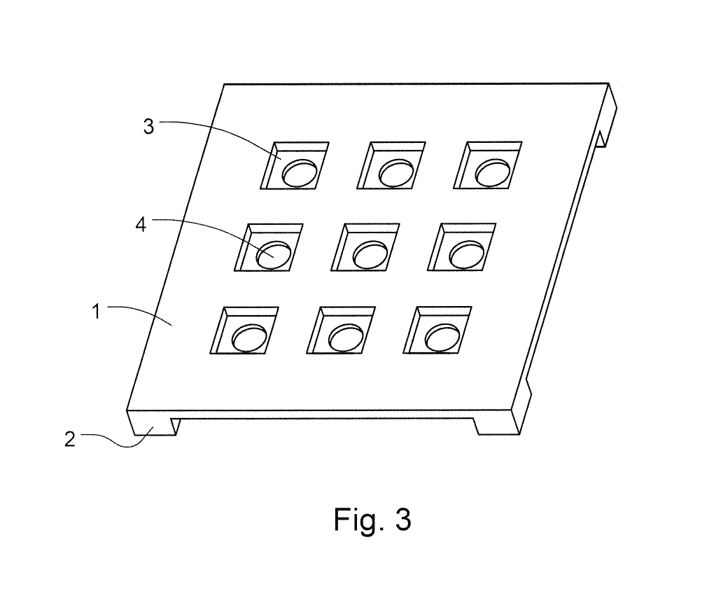

First, please refer to FIG. 3, which discloses the appearance of the structure according to the present invention. The present invention mainly comprises a plate 1, a plurality of supporting legs 2, a plurality of fixing recesses 3, and a plurality of gap parts 4. The plurality of supporting legs 2 are disposed under the plate 1. The plurality of fixing recesses 3 are located on the surface of the plate 1. At minimum, only one recess can be disposed. Moreover, the plurality of gap parts 4 are located at the bottom of the plurality of fixing recesses 3 and penetrating the plate 1.

In the structure according to the present invention, the plate 1 is used for providing support and positioning the bulk of the ball lens of the solar cell receiver module. In addition, the plate 1 is also used as the light-blocking structure for sheltering the circuit of the solar cell receiver module. The material of the plate 1 can be metal or any material resistive to deformation for bearing the weight of multiple ball lenses. Considering that the surface of the plate 1 will be illuminated by the sunlight, in addition to the rigid property, adoption of thermally conductive material can further facilitate heat dissipation. The manufacturing method of the plate 1 is not limited; any process technology can be adopted.

As described above, the plate 1 can provide support and position the ball lens of the solar cell receiver module. In order to fix the rollable ball lens on the plate 1, the fixing recess 3 on the plate 1 according to the present invention can be used as the characteristic structure for limiting the movement of the ball lens. Concurrently, the location of the fixing recess 3 on the surface of the plate 1 also has the effects of positioning the ball lenses and arranging the ball lenses in an array.

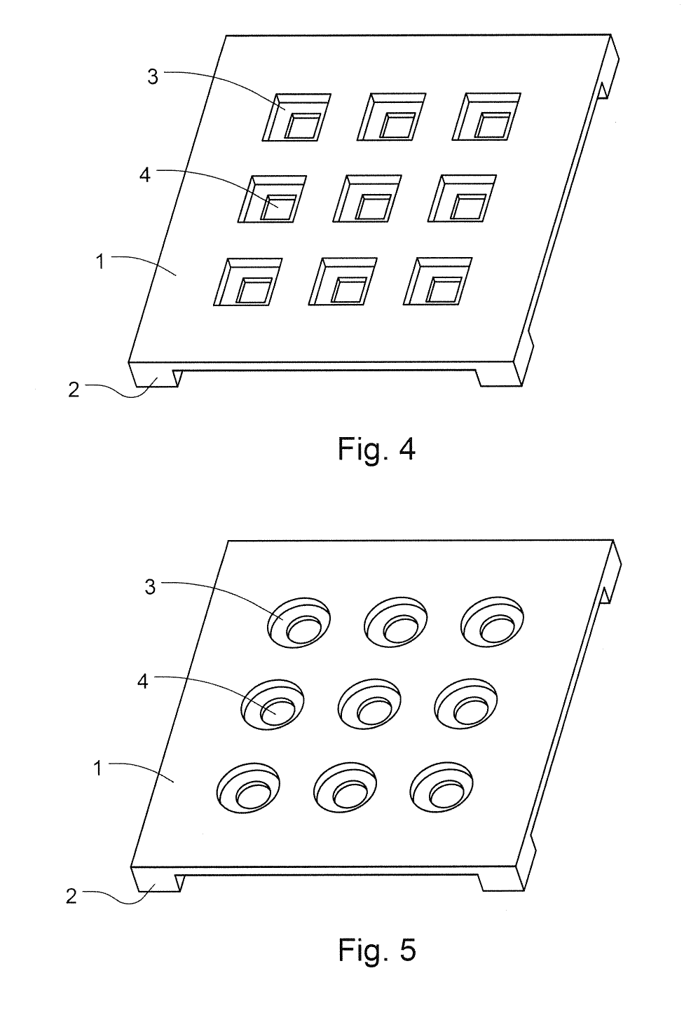

The fixing recess 3 is a recess structure on the surface of the plate 1. The gap part 4 is further disposed at the bottom of center of the fixing recess 3, so that when the ball lens is placed in the fixing recess 3, the ball lens is carried and fixed by contacting the top of the inner edge of the gap part 4. Please refer to FIGS. 4 and 5. The shapes of the fixing recess 3 and the gap part 4 can be circular or rectangular. Nonetheless, considering that the ball lens is a perfect sphere, a circular gap part 4 can reach the best carrying and fixing effect. If the structure of the gap part 4 is to be further varied, a regular polygon will be preferred for ensuring that the contact between the ball lens and the inner edge of the gap part 4 is symmetrical in all directions.

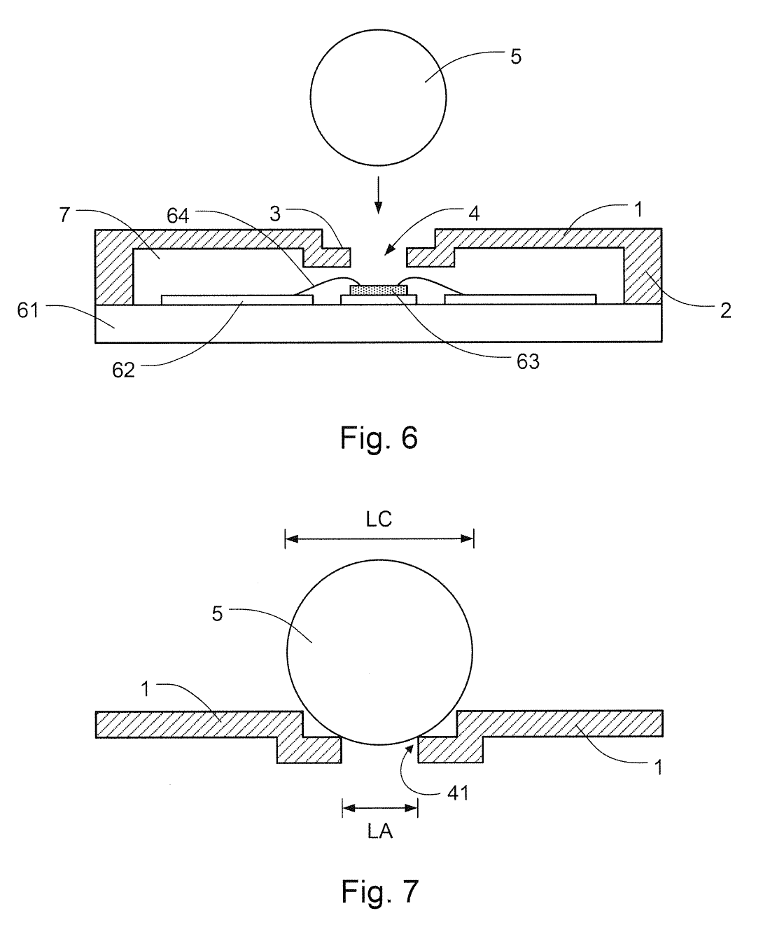

Please refer to FIG. 6, which shows a side cross-sectional view of installing the present invention on a solar cell receiver module with the ball lens' presence. Besides, FIG. 7 shows a partially enlarged view of FIG. 6. As shown in the figures, the ball lens 5 is disposed on the plate 1 and located in the fixing recess 3 on the plate 1. The ball lens 5 is fixed by the top 41 of the inner edge of the gap part 4 in the fixing recess 3. The plate 1 is disposed on the substrate 61 via the supporting legs 2. Thanks to the height of the supporting legs 2, there is an accommodating space 7 between the plate 1 and the substrate 61. The method for connecting the supporting legs 2 and the substrate 61 is not limited. It can be gluing, tenon connection, or screw connection.

On the substrate 61, general structures and devices, such as the conductive circuit 62, the solar cell 63, and the gold wires 64 shown in FIG. 6, of a solar cell receiver module is placed. The plurality of conductive circuit is disposed on the substrate 61 and can be divided in to multiple conductive blocks. The solar cell 63 is placed on one of the conductive circuits 62. Then the solar cell 63 is connected electrically with other conductive circuits 62 by means of the gold wires 64.

Except the solar cell 63, the devices on the substrate 61 as described above benefit by the shelter of the plate 1 and thereby will not be damaged and burned out due to the focus of off-axis sunlight. In addition, by means of the supporting legs 2, the plate 1 provides the accommodating space 7 for allowing the plurality of devices to be located in this region and protected by the shelter.

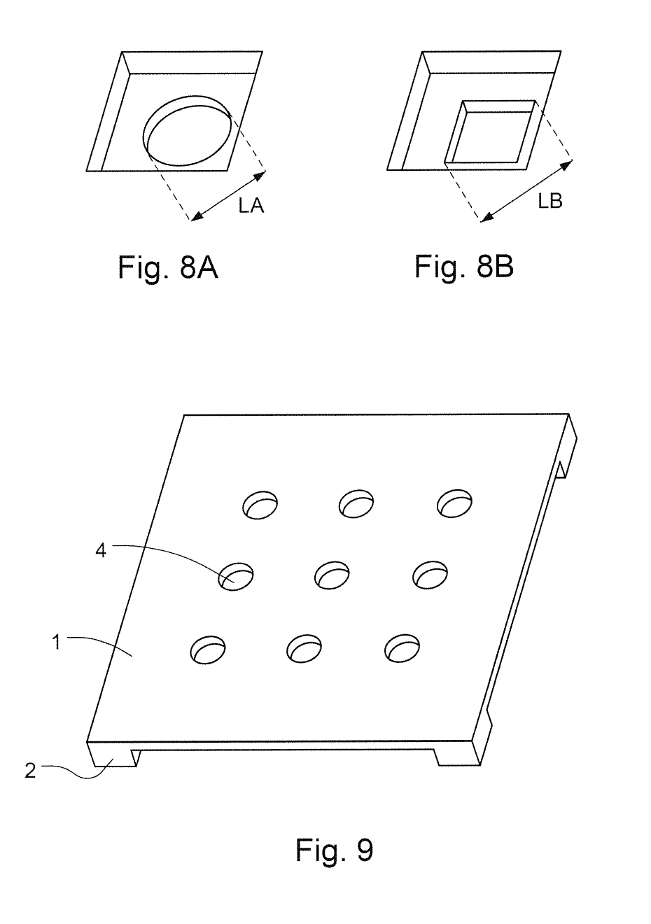

Furthermore, please refer to FIGS. 7, 8A, and 8B. In order to enable the gap part 4 according to the present invention to carry and fix the ball lens 5, the diameter LA of the circular gap part 4 or the longest diagonal LB of the polygonal gap part 4 must be shorter than the diameter LC of the ball lens 5 for preventing the ball lens 5 from falling through the gap part 4 directly. In addition, the diameter LA of the circular gap part 4 or the longest diagonal LB of the polygonal gap part 4 described above should not be excessively small. This is because the gap part 4 is an opening allowing the sunlight to pass through the plate 1 and illuminate the solar cell underneath. If the area is too small, the light illumination on the solar cell is limited, and thus influencing the operating efficiency of the solar cell.

The depth of the fixing recess 3 will influence the distance between the ball lens 5 and the solar cell 63 and can be adjusted during the fabrication process of the present invention according to the requirement. Once the depth of the fixing recess 3 is determined during the fabrication process, the distance between the ball lens 5 and the solar cell 63 will be fixed accordingly. Thereby, while using the present invention as the medium for positioning the ball lens 5, accurate control of the distance between the ball lens 5 and the solar cell 63 is another advantage of the present invention, which makes the assembly quality of the array of solar cell receiver modules superior.

Finally, FIG. 9 shows another simpler embodiment according to the present invention. The present embodiment omits the fabrication of the fixing recesses 3 in the previous embodiment. Instead, the gap parts 4 are disposed on and penetrating the plate 1. Thereby, the ball lens can be placed and positioned on the gap parts 4.

To sum up, the present invention discloses the structure of a fixing apparatus for ball lens. For improving the power generating effect, solar cell receiver modules are disposed in a large-area array. Due to its complicated assembly and error proneness, the present invention is provided for solving the inconvenience and drawbacks in assembly at a time. In addition, the present invention can further avoid structural damages caused by off-axis illumination. Consequently, the lifetime of solar cell receiver modules can be extended and the possibility of failure is reduced as well. Thereby, the present invention undoubtedly provides a fixing apparatus for ball lens having practical values.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A fixing apparatus for ball lens, used for fixing at least a ball lens of a concentrator solar cell receiver module, comprising:
a plate, having a plurality of supporting legs underneath; and
at least a fixing recess, disposed on the surface of said plate, having a gap part at the bottom and penetrating said plate;
where the diameter of said gap part or the longest diagonal is shorter than the diameter of said ball lens and said ball lens contacts the top of an inner edge of said gap part.

2. The fixing apparatus for ball lens of claim 1, wherein said fixing recess is circular or rectangular.

3. The fixing apparatus for ball lens of claim 1, wherein said gap part is circular or rectangular.

4. The fixing apparatus for ball lens of claim 1, wherein said plate is disposed on a substrate by said plurality of supporting legs and there is an accommodating space between said plate and said substrate.

5. The fixing apparatus for ball lens of claim 4, wherein said plurality of supporting legs are glued, tenon connected, or screw connected to said substrate.

6. The fixing apparatus for ball lens of claim 4, wherein said accommodating space has at least a solar cell located below said gap part.

7. The fixing apparatus for ball lens of claim 1, wherein said accommodating space has at least a solar cell.

8. The fixing apparatus for ball lens of claim 7, wherein said solar cell is connected with a plurality of conductive circuits disposed below said plate.

9. A fixing apparatus for ball lens, used for fixing at least a ball lens of a concentrator solar cell receiver module, comprising:
a plate, having a plurality of supporting legs underneath; and
at least a gap part, disposed on the surface of said plate, and penetrating said plate;
where the diameter of said gap part or the longest diagonal is shorter than the diameter of said ball lens, and said ball lens contacts the top of an inner edge of said gap part.
